(19) United States
(12) Patent Application Publication
(10) Pub. No.: US 2023/0230716 A1
(43) Pub. Date: Jul. 20, 2023

(54) NUCLEAR POWER PLANT AND TURBINE APPARATUS

(71) Applicant: Hitachi-GE Nuclear Energy, Ltd., Ibaraki (JP)

(72) Inventors: Daiki NUNOKAWA, Ibaraki (JP); Ko AKATSU, Ibaraki (JP)

(21) Appl. No.: 18/080,822

(22) Filed: Dec. 14, 2022

(30) Foreign Application Priority Data
Jan. 18, 2022 (JP) 2022-005552

(51) Int. Cl. G21D 5/06; F22B 37/00; F01K 7/16

(52) U.S. Cl. CPC G21D 5/06; F22B 37/002; F01K 7/16

(57) ABSTRACT

A nuclear power plant includes: a nuclear reactor; a steam turbine that is driven by main steam that has been generated by the nuclear reactor; and a gland steam supply device that supplies gland steam to a gland of the steam turbine. The gland steam supply device includes a gland steam generator that heats external water, and generates the gland steam. The external water is independent of the main steam and condensate of the main steam.

### CROSS-REFERENCE TO RELATED APPLICATION

The present application claims priority from Japanese application JP2022-005552, filed on Jan. 18, 2022, the contents of which is hereby incorporated by reference into this application.

### BACKGROUND

### Technical Field

The present invention relates to a nuclear power plant and a turbine apparatus.

### Related Art

As a technology relating to a turbine apparatus installed in a nuclear power plant, the technology disclosed in Patent Literature 1 listed below has been proposed. Patent Literature 1 describes “. . . water supplied from the CST tank 6 is heated by using high-temperature steam supplied through the main steam header 4, and therefore clean steam is generated. This clean steam is supplied to a gland, which is a clearance between a shaft 8 of the turbine 1 and a turbine casing 9, through a steam seal header 7 that is coupled to the gland steam evaporator 5 and a bearing of each of the high-pressure or low-pressure turbines 1. On the other hand, steam that has flowed to an outside of the turbine 1 is transferred to a steam backing exhaust header 11 having slightly negative pressure that is coupled to a shaft sealing portion of each of the high-pressure or low-pressure turbines 1. The steam backing exhaust header 11 is coupled to a barrel side of a gland steam condenser 12, and the condenser 12 condenses steam that has flowed through the exhaust header 11. Non-condensable gas generated in condensation is guided to an air exhaust device 13, and is discharged from an exhaust tube”.

### CITATION LIST

### Patent Literature

### Patent Literature 1: JP S62-102194 A

### SUMMARY

However, for example, in the case of a boiling water reactor, water stored in a condensate storage tank (CST tank) is continuously exchanged for primary cooling water obtained by condensing main steam that has been generated by a nuclear reactor pressure vessel. Therefore, water supplied from the CST tank contains tritium that is constantly made in a core of the nuclear power plant during operation. Accordingly, the “clean steam” that has been generated by heating water supplied from the CST tank also contains tritium. Here, tritium has a characteristic of not being removed by a filter or an ion adsorption resin. Therefore, in a case where non-condensable gas that has been exhausted from the gland, has not been condensed by the gland steam condenser, and is discharged from the exhaust tube contains tritium, tritium, which is a radioactive substance, is discharged together with the non-condensable gas to the atmosphere.

In view of the above, it is an object of the present invention to provide a nuclear power plant that is capable of avoiding the discharge of a radioactive substance to the atmosphere, and a turbine apparatus that is installed in this nuclear power plant.

In order to solve the problem described above, for example, the configurations described in the claims are employed.

The present application includes plural solutions to the problem described above, and an example of the solutions is a nuclear power plant including: a nuclear reactor; a steam turbine that is driven by main steam that has been generated by the nuclear reactor; and a gland steam supply device that supplies gland steam to a gland of the steam turbine, in which the gland steam supply device includes a gland steam generator that heats external water, and generates the gland steam, the external water being independent of the main steam and condensate of the main steam.

According to the present invention, a nuclear power plant that is capable of avoiding the discharge of a radioactive substance to the atmosphere, and a turbine apparatus that is installed in this nuclear power plant can be provided.

Problems, configurations, and effects other than the above will become apparent from the description below of an embodiment.

### BRIEF DESCRIPTION OF DRAWINGS

FIG. 1 is a schematic diagram illustrating a configuration of a nuclear power plant according to an embodiment;

FIG. 2 is a diagram illustrating a turbine apparatus that is installed in the nuclear power plant according to the embodiment; and

FIG. 3 is a perspective view illustrating a principal portion of the turbine apparatus.

### DETAILED DESCRIPTION

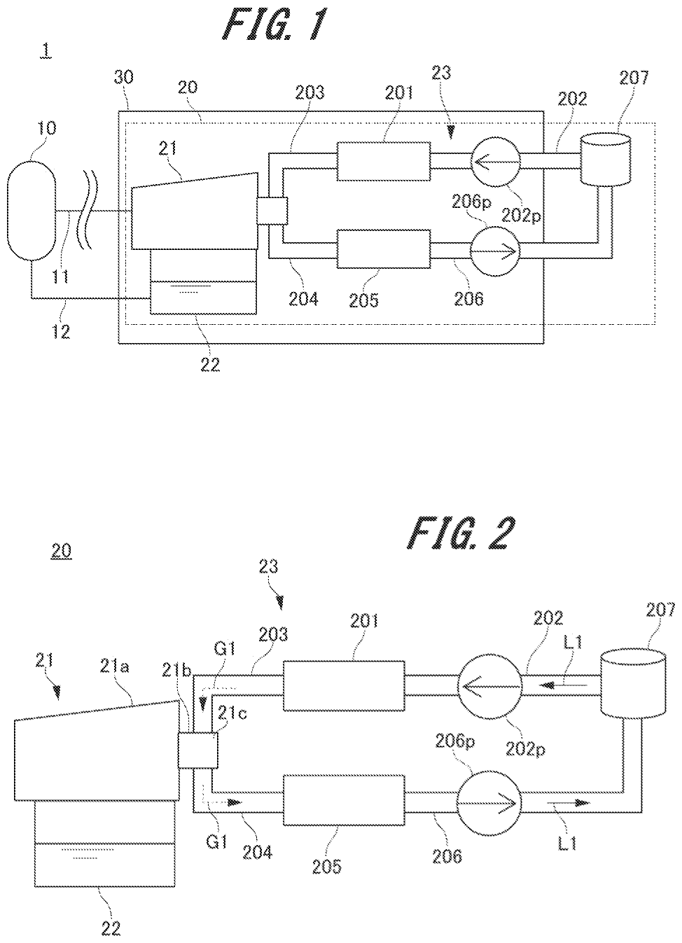

FIG. 1 is a schematic diagram illustrating a configuration of a nuclear power plant 1 according to an embodiment, and is a diagram in which the present invention has been applied to a boiling water reactor (BWR). The nuclear power plant 1 according to the present invention has a configuration that is suitable for a nuclear power plant that boils primary coolant, and generates main steam, such as the illustrated boiling water reactor. A configuration of the nuclear power plant 1 according to the embodiment is described below with reference to this drawing.

As illustrated in FIG. 1, the nuclear power plant 1 includes a nuclear reactor 10, a turbine apparatus 20, and a turbine building 30. These are described below.

### Nuclear Reactor

The nuclear reactor 10 is, for example, of a boiling water type, and the nuclear reactor 10 directly boils primary cooling water in the nuclear reactor 10, and generates steam. The steam generated in the nuclear reactor 10 is transmitted to the turbine apparatus 20 through a main steam pipe 11, and serves as main steam that drives the turbine apparatus 20. The main steam that has been restored to water in the turbine apparatus 20 is returned to the nuclear reactor 10 through a condensate pipe 12.

### Turbine Apparatus

The turbine apparatus 20 is connected to the nuclear reactor 10 through the main steam pipe 11 and the condensate pipe 12. FIG. 2 is a diagram illustrating the turbine apparatus 20 that is installed in the nuclear power plant 1 according to the embodiment. As illustrated in FIG. 1 descried above and FIG. 2, the turbine apparatus 20 includes a steam turbine 21, a condenser 22, and a gland steam supply device 23. These have the following configurations.

### Steam Turbine

The steam turbine 21 houses a turbine (not illustrated) in a casing 21a, rotates the turbine by using the main steam that has been supplied into the casing 21a from the main steam pipe 11 that is connected to the nuclear reactor 10, and drives a power generator that is not illustrated in this drawing. The casing 21a of the steam turbine 21 includes a turbine bearing 21b. The turbine bearing 21b provides a clearance called a gland 21c between the turbine bearing 21b and a rotary shaft of the turbine, and supports the rotary shaft of the turbine. This gland 21c includes a pressure difference buffer mechanism called a labyrinth packing.

Note that the drawings illustrate a configuration in which the turbine bearing 21b is provided on one side of the casing 21a, but the turbine bearing 21b is provided on both sides of the casing 21a, and supports the rotary shaft of the turbine on both sides of the casing 21a.

Furthermore, in the drawings, one steam turbine 21 is illustrated, but the nuclear power plant 1 may include a plurality of steam turbines. The plurality of steam turbines provided in the nuclear power plant 1 are a high-pressure turbine, an intermediate-pressure turbine, a low-pressure turbine, and the like, and the main steam from the nuclear reactor 10 is supplied in series in order from a high-pressure side.

### Condenser

The condenser 22 condenses the main steam that has been supplied from the nuclear reactor 10 through the main steam pipe 11 to the steam turbine 21 to convert the main steam into water, and supplies the converted water as primary coolant to the nuclear reactor 10 through the condensate pipe 12.

### Gland Steam Supply Device

The gland steam supply device 23 supplies gland steam to the gland 21c of the steam turbine 21. Here, the gland steam is steam to be supplied to the gland 21c of the steam turbine 21, and is sealing steam that maintains the clearance between the turbine bearing 21b and the shaft of the turbine, and seals an inside of the casing 21a. The gland steam supply device 23 that supplies such gland steam includes a gland steam generator 201, an external water supply pipe 202, a gland steam supply pipe 203, a gland steam recovery pipe 204, a gland steam condenser 205, an external water recovery pipe 206, and a water storage tank 207.

### Gland Steam Generator

The gland steam generator 201 generates gland steam G1 to be supplied to the gland 21c. Such a gland steam generator 201 heats external water L1 that has been supplied from the external water supply pipe 202 described next to generate gland steam obtained by vaporizing the external water L1. Here, it is assumed that the external water L1 is water serving as primary coolant to be used in the nuclear reactor 10, and water that has been introduced from an external water source that is independent of the main steam generated by the nuclear reactor 10, and an example of the external water L1 is tap water.

In the gland steam generator 201, a heat source that is used to heat the external water L1 is not particularly limited, but main steam that is used to rotate the turbine can be typically used. In this case, an intermediate portion of a pipe that is provided to branch from the main steam pipe 11 is laid in the gland steam generator 201, a distal end of the pipe is connected to the condenser 22, and the main steam is returned to the condenser 22.

### External Water Supply Pipe

The external water supply pipe 202 includes a supply pump 202p, and supplies the external water L1 from an external water source to the gland steam generator 201. Note that it is sufficient if the external water source is a water source that is independent of the nuclear reactor 10, and it is assumed here that the external water source is the water storage tank 207 described later. Such an external water supply pipe 202 is connected to the gland steam generator 201 and the water storage tank 207 that is the external water source, and supplies the external water L1 in the water storage tank 207 to the gland steam generator 201 by using the supply pump 202p that is provided in the intermediate portion.

### Gland Steam Supply Pipe

The gland steam supply pipe 203 supplies the gland steam G1 generated by the gland steam generator 201 to the gland 21c of the steam turbine 21. Such a gland steam supply pipe 203 is provided to be connected to the gland steam generator 201 and the turbine bearing 21b. In a case where the nuclear power plant 1 includes a plurality of steam turbines, the gland steam supply pipe 203 may be connected in parallel to the glands 21c of the respective steam turbines 21. Note that it is assumed that the gland steam supply pipe 203 includes a control mechanism to avoid leakage of the main steam from the gland 21c and leakage of the gland steam G1 into the casing 21a, and supply the gland steam G1 at a predetermined pressure that enables the gland 21c to be sealed. In such a gland 21c, it is assumed that contact between the gland steam G1 and the main steam is avoided.

### Gland Steam Recovery Pipe

The gland steam recovery pipe 204 recovers leakage steam that is the gland steam G1 that has passed through the gland 21c, and has leaked out from the gland 21c, and supplies the leakage steam to the gland steam condenser 205 described next. Such a gland steam recovery pipe 204 is provided to be connected to the turbine bearing 21b and the gland steam condenser 205. In a case where the nuclear power plant 1 includes a plurality of steam turbines, the gland steam recovery pipe 204 may be connected in parallel to the glands 21c of the respective steam turbines 21.

### Gland Steam Condenser

The gland steam condenser 205 condenses the gland steam G1 that has been supplied from the gland steam recovery pipe 204, and restores the gland steam G1 to the external water L1. A cooling source of the gland steam condenser 205 is not particularly limited, but a cooling water from the outside (for example, tap water) can be typically used.

In this case, it is sufficient if an intermediate portion of a tap water pipe that is not illustrated in this drawing is laid in the gland steam condenser 205.

Furthermore, this gland steam condenser 205 includes an exhaust facility (not illustrated) that discharges remaining non-condensable gas that has not been condensed into the external water L1 to the outside.

### External Water Recovery Pipe

The external water recovery pipe 206 includes a recovery pump 206p, recovers the external water L1 that has been cooled down by the gland steam condenser 205 to become liquid, and stores the external water L1 in the water storage tank 207 described next. Such an external water recovery pipe 206 is connected to the gland steam condenser 205 and the water storage tank 207 that is the external water source. Then, the external water recovery pipe 206 recovers the external water L1 in the gland steam condenser 205, and stores the external water L1 in the water storage tank 207, by using the recovery pump 206p that is provided in an intermediate portion.

### Water Storage Tank

The water storage tank 207 is used as an external water source that stores the external water L1 that has been introduced from a water source of the external water L1 that is independent of the primary cooling water of the nuclear reactor 10 and the main steam. This water storage tank 207 is connected to the external water supply pipe 202 and the external water recovery pipe 206. The supply pump 202p and the recovery pump 206p are driven, and therefore the external water L1 inside the water storage tank 207 and the gland steam G1 are forcibly circulated. Then, the external water L1 that has been recovered and has been stored in the water storage tank 207 can be reused.

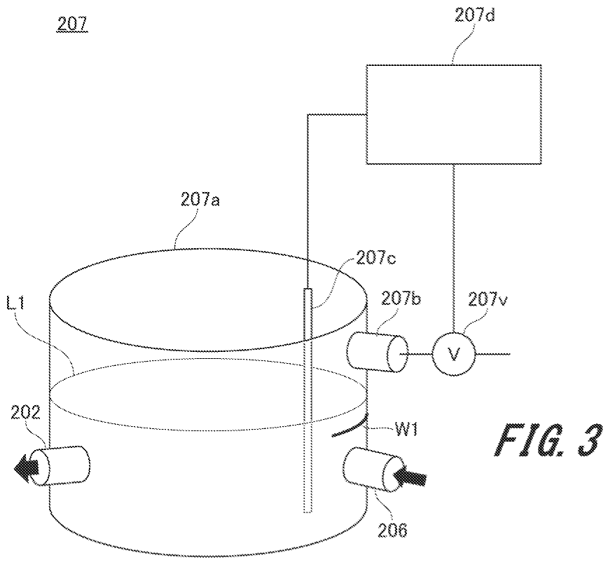

FIG. 3 is a perspective view in which the water storage tank 207 has been enlarged. As illustrated in FIG. 3, the water storage tank 207 includes a tank body 207a, an external water replenishment pipe 207b, a water storage amount measuring instrument 207c, and a controller 207d.

### Tank Body 207a

The tank body 207a stores the external water L1 that has been extracted from a water source that is independent of the primary cooling water to be used in the nuclear reactor 10 (see FIG. 1) or the main steam generated by the nuclear reactor 10. In this tank body 207a, a predetermined required water storage amount W1 has been set in advance. It is assumed that this required water storage amount W1 has been set to a value that does not hinder the supply of the gland steam G1 to the gland 21c of the steam turbine 21.

Such a tank body 207a has, for example, the illustrated cylindrical shape, and a side wall of the tank body 207a is connected to the external water supply pipe 202 and the external water recovery pipe 206. It is assumed that the external water supply pipe 202 and the external water recovery pipe 206 that have been described above are connected to the tank body 207a in positions below a water level indicating the required water storage amount W1.

### External Water Replenishment Pipe 207b

The external water replenishment pipe 207b replenishes an inside of the tank body 207a with the external water L1 from the water source of the external water L1. This external water replenishment pipe 207b includes an opening/closing valve 207v that is used to control replenishment of the tank body 207a with the external water L1. Such an external water replenishment pipe 207b may be, for example, a water pipe, or a pipe that is connected to the water pipe.

### Water Storage Amount Measuring Instrument 207c

The water storage amount measuring instrument 207c measures a water storage amount of the external water L1 in the tank body 207a. This water storage amount measuring instrument 207c is, for example, a water level indicator. In the water level indicator, a method for measuring a water level is not limited, and may be either a contact type method or a non-contact type method. Note that a signal from the water storage amount measuring instrument 207c is transmitted to a control room of the nuclear power plant 1, and in the control room, a water storage amount in the tank body 207a can be checked.

### Controller 207d

The controller 207d performs control to cause the opening/closing valve 207v to open or close the external water replenishment pipe 207b, on the basis of a water storage amount in the tank body 207a that has been measured by the water storage amount measuring instrument 207c, and makes sure that the water storage amount of the external water L1 in the tank body 207a is greater than or equal to the required water storage amount W1.

Note that it has been described that the water storage tank 207 secures the required water storage amount W1 on the basis of the water storage amount measured by the water storage amount measuring instrument 207c. However, this is not restrictive, and for example, a constant water level valve may be provided to secure a water level that causes the required water storage amount W1. Moreover, a particular controller 207d may be omitted from the water storage tank 207. In this case, it is sufficient if an operator checks a water storage amount in the tank body 207a on the basis of a signal from the water storage amount measuring instrument 207c in the control room, and opens or closes the opening/closing valve 207v to secure the required water storage amount W1.

### Turbine Building

Returning to FIG. 1, the turbine building 30 houses the turbine apparatus 20. The turbine building 30 houses machine portions excluding the water storage tank 207 of the turbine apparatus 20. Stated another way, the turbine building 30 houses respective machine portions including the steam turbine 21, the condenser 22, and the gland steam generator 201, the supply pump 202p, the gland steam condenser 205, and the recovery pump 206p of the gland steam supply device 23. Furthermore, the turbine building 30 houses the power generator (not illustrated) that is driven by the steam turbine 21. However, exhaust gas from the exhaust facility provided in the gland steam condenser 205 is discharged to an outside of the turbine building 30.

The turbine building 30 houses these machine portions, and this can avoid damage of the machine portions included in the turbine apparatus 20 due to exposure to the weather. Furthermore, the water storage tank 207 is provided outside the turbine building 30, and this can avoid an increase in size of the turbine building 30. Moreover, a degree of freedom of a position of installment of the water storage tank 207 can be increased, and therefore an operator can easily adjust the supply of the external water L1 to an inside of the tank body 207a.

### Effects of Embodiment

The nuclear power plant 1 described above is configured to seal the gland 21c of the steam turbine 21, by using the gland steam G1 obtained by causing the gland steam generator 201 to vaporize the external water L1 that is independent of the main steam. Therefore, the gland steam G1 that has leaked from the gland 21c is independent of the main steam, and does not contain a radioactive substance that can be contained in the main steam.

Accordingly, for example, non-condensable gas that has not been condensed by the gland steam condenser 205 and has been generated does not contain the radioactive substance, and the discharge of the radioactive substance to the atmosphere can be avoided. In particular, tritium contained in the main steam that has been supplied from the nuclear reactor 10 of a boiling water type has a long half-life of about 12 years, and has a characteristic of not being removed by a filter or an ion adsorption resin. However, in the nuclear power plant 1 according to the present embodiment, tritium having such a characteristic is not contained in non-condensable gas that has been generated in condensing the gland steam G1, and the discharge of tritium to the atmosphere can be avoided.

Note that the present invention is not limited to the embodiment and the variations that have been described above, and further includes a variety of variations. For example, the embodiment described above has been described in detail in order to make the present invention easily understandable, and the present invention is not necessarily limited to an embodiment that includes all of the described configurations. Furthermore, part of a configuration according to a certain embodiment can be replaced with a configuration according to another embodiment, or a configuration according to another embodiment can be added to a configuration according to a certain embodiment.

Moreover, another configuration can be added to, deleted from, or substituted for part of a configuration according to each of the embodiments.

What is claimed is:

1. A nuclear power plant comprising:
a nuclear reactor;
a steam turbine that is driven by main steam that has been generated by the nuclear reactor; and
a gland steam supply device that supplies gland steam to a gland of the steam turbine, wherein
the gland steam supply device includes a gland steam generator that heats external water, and generates the gland steam, the external water being independent of the main steam and condensate of the main steam.

2. The nuclear power plant according to claim 1, wherein
the gland steam supply device includes a gland steam condenser that condenses the gland steam that has leaked out from the gland, and restores the gland steam to water.

3. The nuclear power plant according to claim 1, wherein
the gland steam supply device includes:
a water storage tank that stores the external water to be supplied to the gland steam generator; and
an external water supply pipe that supplies the external water in the water storage tank to the gland steam generator.

4. The nuclear power plant according to claim 1, wherein
the gland steam supply device includes:
a gland steam condenser that condenses the gland steam that has leaked out from the gland, and restores the gland steam to water;
a water storage tank that stores, as the external water, the water that has been obtained by the gland steam condenser;
an external water recovery pipe that recovers the water that has been obtained by the gland steam condenser, and stores the water in the water storage tank; and
an external water supply pipe that supplies the external water in the water storage tank to the gland steam generator.

5. The nuclear power plant according to claim 4, further comprising
a turbine building that houses the steam turbine, a recovery pump that is installed in the external water recovery pipe, and a supply pump that is installed in the external water supply pipe.

6. The nuclear power plant according to claim 5, wherein
the water storage tank is installed outside the turbine building.

7. The nuclear power plant according to claim 3, wherein
the water storage tank includes:
a tank body that stores the external water;
a water storage amount measuring instrument that measures a water storage amount of the tank body; and
an external water replenishment pipe that introduces the external water to the tank body.

8. The nuclear power plant according to claim 7, wherein
the water storage tank includes a controller that performs control to introduce the external water from the external water replenishment pipe to the tank body, on a basis of information from the water storage amount measuring instrument.

9. The nuclear power plant according to claim 1, wherein
the nuclear reactor boils primary coolant, and generates the main steam.

10. A turbine apparatus comprising:
a steam turbine that is driven by main steam; and
a gland steam supply device that supplies gland steam to a gland of the steam turbine, wherein
the gland steam supply device includes a gland steam generator that heats external water, and generates the gland steam, the external water being independent of the main steam and condensate of the main steam.

11. The turbine apparatus according to claim 10, wherein
the gland steam supply device includes a gland steam condenser that condenses the gland steam that has leaked out from the gland, and restores the gland steam to water.

12. The turbine apparatus according to claim 10, wherein
the gland steam supply device includes:
a water storage tank that stores the external water to be supplied to the gland steam generator; and
an external water supply pipe that supplies the external water in the water storage tank to the gland steam generator.

13. The turbine apparatus according to claim 10, wherein
the gland steam supply device includes:
a gland steam condenser that condenses the gland steam that has leaked out from the gland, and restores the gland steam to water;
a water storage tank that stores, as the external water, the water that has been obtained by the gland steam condenser;
an external water recovery pipe that recovers the water that has been obtained by the gland steam condenser, and stores the water in the water storage tank; and
an external water supply pipe that supplies the external water in the water storage tank to the gland steam generator.
